(19) United States
(12) Patent Application Publication
(10) Pub. No.: US 2024/0317472 A1
(43) Pub. Date: Sep. 26, 2024

(54) METHODS FOR FORMING CELLULOSIC-BASED CONTAINERS, RELATED ARTICLES, AND RELATED COMPOSITIONS

(71) Applicant: BOARD OF TRUSTEES OF MICHIGAN STATE UNIVERSITY, East Lansing, MI (US)

(72) Inventors: Muhammad Rabnawaz, East Lansing, MI (US); Dhwani Kansal, East Lansing, MI (US)

(21) Appl. No.: 18/269,327

(22) PCT Filed: Jan. 7, 2022
(86) PCT No.: PCT/US22/11528

§ 371 Date: Jun. 23, 2023

Related U.S. Application Data
(60) Provisional application No. 63/135,324, filed on Jan. 8, 2021.

(51) Int. Cl. B65D 53/06; F16J 15/14

(52) U.S. Cl. CPC B65D 53/06; F16J 15/14

(57) ABSTRACT

The disclosure relates to a method for sealing a cellulosic article in which a sealing solution is applied to one or more cellulosic substrates to form a seal between surfaces thereof. The sealing solution generally includes water, starch, a solid polyol plasticizer, and optionally a liquid polyol plasticizer. Coated surfaces of the cellulosic substrate(s) are then contacted under sufficient conditions to form the seal therebetween, for example after drying and/or with sufficient contact time, contact pressure, contact temperature, etc. The disclosure further relates to a corresponding sealed cellulosic article, for example as formed by the sealing method. The disclosure further relates to a method for recycling in which the sealed cellulosic article is re-pulped, with or without recovery of sealing composition components, then formed into a recycled cellulosic substrate.

### CROSS REFERENCE TO RELATED APPLICATION

Priority is claimed to U.S. Provisional Application No. 63/135,524 filed on Jan. 8, 2021, which is incorporated herein by reference in its entirety.

### STATEMENT OF GOVERNMENT INTEREST

None.

### BACKGROUND OF THE DISCLOSURE

### Field of the Disclosure

The disclosure relates to a method for sealing a cellulosic article in which a sealing solution is applied to one or more cellulosic substrates to form a seal between surfaces thereof. The sealing solution generally includes water, starch, a solid polyol plasticizer, and optionally a liquid polyol plasticizer. Coated surfaces of the cellulosic substrate(s) are then contacted under sufficient conditions to form the seal therebetween. The disclosure further relates to a corresponding sealed cellulosic article and a method for recycling the same.

### Brief Description of Related Technology

Plastics such as polypropylene or polyethylene are currently used as packaging material for many goods. Regulations on single-use plastics are becoming stricter worldwide. The replacement of these single-use plastics with paper that could be repulped and recycled is limited, because current routes of sealing paper packages still use glues, plastics, and other additives that are hard to separate during the repulping process.

### SUMMARY

The disclosed methods, compositions, and articles address these limiting factors related to repulping and the use of paper or other cellulosic-based substrates as packaging materials, articles, containers, etc. As described in more detail below, thermosealing of cellulosic-based substrates with water soluble polymers and various polyol plasticizers allows for easy repulping and recycling of the cellulosic-based substrate, either with or without separation of the thermosealing material from paper fibers during the recycling process. In some embodiments and as described below, the water-soluble polymer used in the sealing solution or sealing composition can include starch, for example an unmodified starch or a modified starch. In some embodiments, a water-soluble polymer other than starch can be used in the sealing solution or sealing composition, for example a polyvinylalcohol. In such embodiments, the various amount, ratios, concentrations, etc. described for starch can apply more generally to the water-soluble polymer other than starch included in a particular sealing solution or sealing composition. In some embodiments, more than one water-soluble polymer can be included in the sealing solution or sealing composition (e.g., as a blend of two or more water-soluble polymers).

In one aspect, the disclosure relates to a method for sealing a cellulosic article, the method comprising: applying a sealing solution to a first surface of a cellulosic substrate, the sealing solution comprising: (i) water in an amount of at least 60 wt. % or 80 wt. % based on the sealing solution, (ii) starch (or a water-soluble polymer more generally) in an amount in a range of 1 wt. % to 20 wt. %, 1 wt. % to 30 wt. %, or 2 wt. % to 20 wt. % based on the sealing solution, and (iii) a solid polyol plasticizer in an amount in a range of 0.5 wt. % to 10 wt. %, 0.5 wt. % to 15 wt. %, or 1 wt. % to 10 wt. % based on the sealing solution; and contacting a second surface of a cellulosic substrate with the sealing solution on the first surface to form a seal between the first surface and the second surface. The sealing solution is generally an aqueous sealing solution with water as the primary component in which the starch and any polyol plasticizers (e.g., sugar alcohol and optional glycerol, etc.) are dissolved. The sealing solution is applied to one or both of the first and second surfaces, which are then contacted under sufficient conditions to form the seal therebetween, for example with sufficient contact time, contact pressure, and/or contact temperature, etc.

In another aspect, the disclosure relates to a cellulosic article comprising: a first surface of a cellulosic substrate sealed to a second surface of a cellulosic substrate formed by the disclosed sealing method in any of its various embodiments, refinements, or alternatives.

In another aspect, the disclosure relates to a cellulosic article comprising: a first surface of a cellulosic substrate sealed to a second surface of a cellulosic substrate at an interface between the first surface and the second surface; and a sealing composition at the interface binding the first surface to the second surface, the sealing composition comprising: (i) starch (or a water-soluble polymer more generally) in an amount in a range of 40 wt. % to 98 wt. % based on the combined amount of starch and all polyol plasticizers in the sealing composition, (ii) a solid polyol plasticizer in an amount in a range of 2 wt. % to 60 wt. % based on the combined amount of starch and all polyol plasticizers in the sealing composition, and (iii) optionally a liquid polyol plasticizer in an amount in a range of 0.5 wt. % to 30 wt. % based on the combined amount of starch and all polyol plasticizers in the sealing composition. In an alternative aspect, the disclosure relates to a cellulosic article (e.g., a coated cellulosic substrate) comprising: a cellulosic substrate having a first surface; and a sealing (or coating) composition at the interface binding the first surface to the second surface, the sealing composition comprising: (i) starch (or a water-soluble polymer more generally) in an amount in a range of 40 wt. % to 98 wt. % based on the combined amount of starch and all polyol plasticizers in the sealing composition, (ii) a solid polyol plasticizer in an amount in a range of 2 wt. % to 60 wt. % based on the combined amount of starch and all polyol plasticizers in the sealing composition, and (iii) optionally a liquid polyol plasticizer in an amount in a range of 0.5 wt. % to 30 wt. % based on the combined amount of starch and all polyol plasticizers in the sealing composition. In an embodiment, a weight ratio of starch to solid polyol plasticizer in the sealing composition is in a range of 0.1 to 40. In an embodiment, the liquid polyol plasticizer is present and a weight ratio of solid polyol plasticizer to liquid polyol plasticizer in the sealing composition is in a range of 0.1 to 20.

Various refinements of the disclosed sealing method, sealing solution, sealing composition, and corresponding articles are possible.

In a refinement, the water is present in the sealing solution in an amount in a range of 80 wt. % to 98 wt. % based on the sealing solution. The sealing solution as initially applied to the first surface (or second surface in some embodiments) can have any suitable amount of water to solubilize the starch and polyol plasticizer components as well as to promote the absorption of the same into the cellulosic substrate before sealing. In some embodiments, the water can be present in amounts of at least 60, 70, 80, 85, 90, or 95 wt. % and/or up to 85, 90, 92, 95, 97, 98, or 99 wt. %.

In a refinement, the starch is selected from the group consisting of unmodified starch, modified starch, and combinations thereof. Starch in its natural or unmodified form is generally a mixture of amylose and amylopectin, for example about 15-30 wt. % amylose and about 70-85 wt. % amylopectin depending on the source of the starch. In various embodiments, separation and/or techniques such as hydrolysis can be used to select a desired distribution of amylose and amylopectin components and/or to control the molecular weight of the starch components. Various modified starches (e.g., modified amylose and/or amylopectin in admixture or separately) are known in the art and can be used. A modified starch is suitably a partially modified starch in which 1% to 90% (e.g., weight, number, or mole basis) of the hydroxyl (OH) groups of the natural starch material have been functionalized, modified, or otherwise replaced with one or more groups such as an alkyl group, acetyl group, alkanoyl group, amine group, ether group, etc. For example, at least 1, 2, 5, 10, 20, 30, 40, or 50% and/or up to 10, 20, 30, 40, 50, 60, 70, 80, or 90% of the native hydroxyl groups have been modified. Likewise, the modified starch can include 10% to 99% (e.g., weight, number, or mole basis) of the original hydroxyl groups relative to the corresponding natural starch, for example at least 20, 30, or 40% and/or up to 60, 70, or 80% of the original hydroxyl groups. Examples of modified starches include partially alkylated starch, partially acetylated/alkanoylated starch, partially aminated starch (and its derivatives), partially etherified starch, etc. The foregoing alkyl, acetyl, alkanoyl, amine, and ether groups can generally be saturated or unsaturated (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., nitrogen atom for the amine group).

In a refinement, the starch is present in the sealing solution in an amount in a range of 1 wt. % to 15 wt. % based on the sealing solution. The sealing solution as initially applied to the first surface (or second surface in some embodiments) can have any suitable amount of starch in view of the desired strength of the eventual seal. In some embodiments, the starch can be present in amounts of at least 1, 2, 3, 4, 5, 6, 8, or 10 wt. % and/or up to 5, 7, 9, 12, 15, 18, 20, 25, or 30 wt. %.

In a refinement, the solid polyol plasticizer contains 4 to 16 carbon atoms and is solid over a range of temperatures from 15 to 35° C. More generally, the solid polyol plasticizer is generally a polyol that is solid at common ambient or intended use temperatures, for example a polyol that is solid over a range of temperatures from 15 to 35° C. or 20 to 30° C. The solid polyol plasticizer can have a melting point of at least 40° C., for example at least 40, 60, 80, 90, 100 or 120° C. and/or up to 100, 120, 140, 160, 180, 200, or 250° C. Such solid polyols can contain 4 to 16 carbon atoms (e.g., 4 to 6, 8, 10, 12, 16 carbon atoms, such as 4, 5, 6, 7, or 8 carbon atoms), for example as a sugar alcohol. Alternatively or additionally the solid polyols can contain 4 to 12 hydroxy or alcohol (—OH) groups (e.g., 4 to 6, 8, 10, or 12 hydroxy groups, such as 4, 5, or 6 hydroxy). In some embodiments, the solid polyol plasticizer can be a partially modified solid polyol such that at least one of the hydroxy groups of the base solid polyol has been functionalized, modified, or otherwise replaced with one or more groups such as an alkyl group, ester group, amine group, carboxylic acid group, etc. The foregoing alkyl, ester, amino, and carboxylic acid groups can generally include saturated or unsaturated components (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., oxygen atoms for the ester or carboxylic acid groups). Such modified solid polyols can retain at least 1, 2, 3, or 4 and/or up to 4, 6, 8, 10, or 12 hydroxy groups.

In a refinement, the solid polyol plasticizer is selected from the group consisting of isosorbide, erythritol, threitol, arabitol, xylitol, ribitol, mannitol, sorbitol, galactitol, fucitol, iditol, inositol, volemitol, isomalt, maltitol, lactitol, and combinations thereof. The foregoing solid polyols can likewise be unmodified or modified as described above with one or more hydroxy or alcohol (—OH) group being functionalized, modified, or otherwise replaced with one or more groups such as an alkyl group, ester group, carboxylic acid group, etc. Such modified solid polyols can retain at least 1, 2, 3, or 4 and/or up to 4, 6, 8, 10, or 12 hydroxy groups.

In a refinement, the solid polyol plasticizer is present in the sealing solution in an amount in a range of 0.5 wt. % to 7.5 wt. % based on the sealing solution. The sealing solution as initially applied to the first surface (or second surface in some embodiments) can have any suitable amount of solid polyol plasticizer(s) in view of the desired strength of the eventual seal. In some embodiments, the solid polyol plasticizer can be present in amounts of at least 0.5, 1, 1.5, 2, 3, 4, or 5 wt. % and/or up to 2.5, 3, 4, 5, 7.5, 10, or 15 wt. %. In embodiments with more than one type of solid polyol plasticizer, the foregoing ranges can apply to total amount of solid polyol plasticizers in the sealing solution.

In a refinement, the starch is present in the sealing solution in an amount in a range of 40 wt. % to 95 wt. % based on the combined amount of starch and all polyol plasticizers in the sealing solution; and the solid polyol plasticizer is present in the sealing solution in an amount in a range of 5 wt. % to 60 wt. % based on the combined amount of starch and all polyol plasticizers in the sealing solution. The composition of the sealing solution alternatively or additionally can be represented on a dry basis, which excludes the water component as well as any other volatile components (if any) in the sealing solution. Such amounts thus include the weight contribution of components remaining in or on the cellulosic substrate after drying or otherwise removing water from the sealing solution after application to the first and/or second surfaces. In an embodiment, the starch can be present in amounts of at least 40, 50, 60, 70, or 80 wt. % and/or up to 60, 70, 80, 90, 95, or 98 wt. % based on the combined amount of starch and all polyol plasticizers. In an embodiment, the solid polyol plasticizer(s) can be present in amounts of at least 2, 5, 10, 15, 20, 25, or 30 wt. % and/or up to 25, 30, 40, 50, or 60 wt. % based on the combined amount of starch and all polyol plasticizers. The foregoing component ranges can likewise apply to the sealing composition in an already-sealed cellulosic article.

In a refinement, a weight ratio of starch to solid polyol plasticizer in the sealing solution is in a range of 0.1 to 40. The composition of the sealing solution alternatively or additionally can be represented by the relative amount of starch to solid polyol plasticizer(s), which reflects the relative amount of the components in the original sealing solution as well as in or on the cellulosic substrate after sealing. In an embodiment, a weight ratio of starch to solid polyol plasticizer(s) in the sealing solution or the cellulosic substrate after sealing is at least 0.1, 0.2, 0.5, 1, 1.5, 2, 2.5, 3, 5, or 10 and/or up to 1.5, 2, 3, 4, 6, 8, 10, 12, 15, 20, 30, 40 (i.e., where values above 1 represent a higher relative amount of starch). The foregoing component ratios can likewise apply to the sealing composition in an already-sealed cellulosic article.

In a refinement, the sealing solution further comprises (iv) a liquid polyol plasticizer in an amount in a range of 0.5 wt. % to 30 wt. % based on the sealing solution. The sealing solution as initially applied to the first surface (or second surface in some embodiments) can further include a liquid polyol plasticizer, which improves the mobility of the starch and solid polyol components upon heating and initial seal formation. This promotes contact, entanglement, and hydrogen bonding between the starch and solid polyol components with the cellulosic components of the substrate (i.e., all of which contain hydroxy groups), which in turn increases the strength of the eventual seal. In some embodiments, the liquid polyol plasticizer can be present in amounts of at least 0.5, 1, 1.5, 2, 2.5, 3, or 4 wt. % and/or up to 2.5, 3, 4, 5, 7.5, 10, 15, 20, or 30 wt. %. In embodiments with more than one type of liquid polyol plasticizer, the foregoing ranges can apply to total amount of liquid polyol plasticizers in the sealing solution.

In a further refinement, the liquid polyol plasticizer contains 2 to 4 carbon atoms and is liquid over a range of temperatures from 15 to 35° C. More generally, the liquid polyol plasticizer is generally a polyol that is liquid at common ambient or intended use temperatures, for example a polyol that is liquid over a range of temperatures from 15 to 35° C. or 20 to 30° C. The liquid polyol plasticizer can have a melting point of up to 30° C., for example at least −150, −100, −50, 0, 5, 10, or 15° C. and/or up to 0, 5, 10, 15, 20, 25, or 30° C. Such liquid polyols can contain 2 to 4 carbon atoms (e.g., 2, 3, or 4 carbon atoms). Alternatively or additionally the liquid polyols can contain 2 to 4 hydroxy or alcohol (—OH) groups (e.g., 2, 3, or 4 hydroxy groups). In some embodiments, the liquid polyol plasticizer can be partially modified starch such that at least one of the hydroxy groups of the base liquid polyol has been functionalized, modified, or otherwise replaced with one or more groups such as an alkyl group, ester group, carboxylic acid group, etc. The foregoing alkyl, ester, and carboxylic acid groups can generally include saturated or unsaturated components (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., oxygen atoms for the ester or carboxylic acid groups). Such modified liquid polyols can retain at 1, 2, or 3 hydroxy groups.

In a further refinement, the liquid polyol plasticizer is selected from the group consisting of glycerin (glycerol), partially alkylated glycerin, partially alkanoated glycerin, diglycerin, triglycerin (e.g., oligo- or poly-glycerin or glycerol), 1,2-ethanediol (ethylene glycol), 1,2-propanediol (propylene glycol), 1,3-propanediol, 1,2-butanediol, 1,3-butanediol, 1,4-butanediol, 2,3-butanediol, and combinations thereof. The foregoing liquid polyols can likewise be unmodified or modified as described above with one or more hydroxy or alcohol (—OH) group being functionalized, modified, or otherwise replaced with one or more groups such as an alkyl group, ester group, carboxylic acid group, etc. Such modified liquid polyols can retain 1, 2, or 3 hydroxy groups.

In a further refinement, the solid polyol plasticizer comprises sorbitol; and the liquid polyol plasticizer comprises glycerin.

In a further refinement, the starch is present in the sealing solution in an amount in a range of 40 wt. % to 98 wt. % based on the combined amount of starch and all polyol plasticizers in the sealing solution; the solid polyol plasticizer is present in the sealing solution in an amount in a range of 2 wt. % to 60 wt. % based on the combined amount of starch and all polyol plasticizers in the sealing solution; and the liquid polyol plasticizer is present in the sealing solution in an amount in a range of 0.5 wt. % to 30 wt. % based on the combined amount of starch and all polyol plasticizers in the sealing solution. As above, the composition of the sealing solution alternatively or additionally can be represented on a dry basis when further including the liquid polyol plasticizer in the sealing solution. The foregoing ranges for the starch and solid polyol plasticizer apply to this embodiment as well. The liquid polyol plasticizer(s) can be present in amounts of at least 0.5, 1, 2, 5, 7, 10, 15, or 20 wt. % and/or up to 10, 15, 20, 25, or 30 wt. % based on the combined amount of starch and all polyol plasticizers. The foregoing component ranges can likewise apply to the sealing composition in an already-sealed cellulosic article.

In a further refinement, a weight ratio of starch to solid polyol plasticizer in the sealing solution is in a range of 0.1 to 40; and a weight ratio of solid polyol plasticizer to liquid polyol plasticizer in the sealing solution is in a range of 0.1 to 20. As above, the composition of the sealing solution alternatively or additionally can be represented by the relative amounts of starch, solid polyol plasticizer(s), and liquid polyol plasticizer(s), which reflects the relative amount of the components in the original sealing solution as well as in or on the cellulosic substrate after sealing. In an embodiment, a weight ratio of starch to solid polyol plasticizer(s) in the sealing solution or the cellulosic substrate after sealing is at least 0.1, 0.2, 0.5, 1, 1.5, 2, 2.5, 3, 5, or 10 and/or up to 1.5, 2, 3, 4, 6, 8, 10, 12, 15, 20, 30, 40 (i.e., where values above 1 represent a higher relative amount of starch). In an embodiment, a weight ratio of solid polyol plasticizer(s) to liquid polyol plasticizer(s) in the sealing solution or the cellulosic substrate after sealing is at least 0.1, 0.2, 0.5, 1, 1.5, 2, 2.5, or 3 and/or up to 1.5, 2, 3, 4, 6, 8, 10, 12, 15 or 20 (i.e., where values above 1 represent a higher relative amount of solid polyol plasticizer(s)). The foregoing component ratios can likewise apply to the sealing composition in an already-sealed cellulosic article.

In a refinement, the cellulosic substrate is selected from the group of paper, corrugated board, cardboard, wood, and fabric. The cellulosic substrate is typically a porous substrate including at least one of cellulose and hemicellulose, and it can further include lignin (e.g., as a lignocellulosic substrate). The cellulosic substrate be selected from paper (bleached, unbleached, coated and uncoated), corrugated board, cardboard, wood, and fabric (or textile). More generally, the cellulosic substrate is not particularly limited, and can be formed from any cellulosic material desired for sealing or joining to form a corresponding article, in particular given the good, broad adhesive capabilities of the sealing solution. For example, the substrate can be a paper, wood, or fabric (or textile). Examples of paper substrates can include generally thinner, flexible papers, for example useful as wrapping materials, as well as generally thicker, rigid papers or cardboard (e.g., corrugated paper cardboard), for example useful as box, container, plate, cup, or other storage or food-service items. Suitable wood materials can be any type of wood commonly used in home, office, and outdoor settings. Suitable fabric or textile materials can include any cellulosic materials commonly used in garments or otherwise, such as cotton, jute, flax, hemp, etc.

In a refinement, the cellulosic substrate is in the form of a food-service article selected from the group consisting of a drinking cup, a food plate, and a food wrapper.

In a refinement, the cellulosic substrate is in the form of a packaging box (e.g., corrugated boxes, cardboard boxes).

In a refinement, the sealing solution further comprises a filler in an amount in a range of 0.01 wt. % to 10 wt. % or 0.01 wt. % to 20 wt. % based on the sealing solution. More generally, the sealing solution or sealing composition can include any suitable organic or inorganic filler or additive, which can be included to improve one or more of mechanical properties (e.g., seal strength), optical properties, electrical properties, and hydrophobic properties of the final seal. The fillers can be added in the range from 0.01 wt. % to 10 wt. % or 0.01 wt. % to 20 wt. %, for example in range from 1 wt. % to 5 wt. % or 1 wt. % to 10 wt. %. Example additives include wood flour, nanoclay, graphene oxide, graphene, silicon dioxide (silica), aluminum oxide, cellulose nanocrystals, carbon nanotubes, titanium dioxide (titania), diatomaceous earth, biocides, pigments, dyes, and/or thermoplastics. The additives can be included in the sealing solution as applied to the cellulosic substrate.

In a refinement, the method sealing method further comprises: after applying the sealing solution to the first surface of the cellulosic substrate, drying the cellulosic substrate thereby removing at least some of the water from the sealing solution. Suitably, the first and/or second surfaces are allowed to dry or are dried prior to contacting to form the seal, which provides time for the starch and any polyol plasticizers to be absorbed into and transported throughout the cellulosic substrate via capillary transport prior to evaporation or removal of water, which in turn provides a stronger eventual seal. Drying can be performed at ambient conditions or with some applied heat. Drying can performed until there is no longer any visible surface water or liquid on the surface of the cellulosic substrate, for example where at least 80, 85, 90, or 95 wt. % and/or up to 90, 95, 98, 99, or 100 wt. % of the water from the initial sealing solution has been removed prior to sealing.

In a refinement, contacting the second surface with the first surface comprises at least one of applying pressure to the first surface and the second surface and applying heat to the first surface and the second surface to form the seal. In various embodiments, application of pressure during sealing can be performed a pressure in a range of 0.5 bar to 30 bar (e.g., about 7 psi to about 440 psi), for example at least 0.5, 1, 2, 5, 7, or 10 bar and/or up to 5, 10, 15, 20, 25, or 30 bar. In various embodiments, application of heat during sealing can be performed a temperature in a range of 100° C. to 400° C., for example being above the melting point of the solid polyol, at least 100, 120, 150, or 200° C., and/or up to 150, 200, 250, 300, or 400° C. In various embodiments, the first and second surfaces can be contacted during application of pressure and/or heat for a contact time in a range of 0.2 s to 10 s.

In a refinement, the second surface comprises a second sealing solution thereon to be contacted with the first surface when forming the seal. In some embodiments, the second surface is uncoated with a sealing solution. In other embodiments, the second surface can also have a sealing solution applied thereto prior to contacting the first and second surfaces to form the seal. The second sealing solution could be the same or different from that applied to the first surface, but the second sealing solution generally has the same options for components, amounts, etc. as the sealing solution applied to the first surface.

In a refinement, the first surface and the second surface are from the same cellulosic substrate. In some embodiments, the sealed surfaces are different regions of the same cellulosic substrate, for example where the substrate is bent, folded, or otherwise shaped/deformed to contact and join the first and second surfaces.

In a refinement, the first surface and the second surface are from different cellulosic substrates. In some embodiments, the sealed surfaces are on different cellulosic substrates, for example where two separate substrates are joined into a unitary article after contacting and joining the first and second surfaces to form the seal.

In another aspect, the disclosure relates to a method for recycling a cellulosic article, the method comprising: providing a cellulosic article in any of its various embodiments, refinements, or alternatives; pulping the cellulosic article in a pulping medium; and forming a recycled cellulosic substrate from the pulped cellulosic article.

In a refinement of the recycling method, the starch, the solid polyol plasticizer, and the liquid polyol plasticizer (when present) are not removed from the pulping medium prior to forming recycled cellulosic substrate. The starch, the solid polyol plasticizer, and the liquid polyol plasticizer initially present in the seal of the original cellulosic article being recycled would generally be solubilized in the pulping medium. In some embodiments, these sealing composition components can remain in the pulping medium and be reincorporated into the recycled cellulosic substrate, for example as a sizing agent. The sealing composition components would generally be homogenously distributed throughout the recycled cellulosic substrate, for example at the relative ratios described above for the sealing composition/sealing solution.

In a refinement of the recycling method, the method further comprises removing and recovering the starch, the solid polyol plasticizer, and the liquid polyol plasticizer (when present) from the pulping medium prior to forming recycled cellulosic substrate. The recovered sealing composition components can be recycled to form a new sealing solution for the sealing of other cellulosic substrates. In contrast to the previous embodiment, the recycled cellulosic substrate would generally not contain the sealing composition components homogeneously distributed throughout.

In a refinement of the recycling method, the method further comprises: performing the disclosed sealing method in any of its various embodiments, refinements, or alternatives on the recycled cellulosic substrate, thereby forming a seal on at least a first surface of the recycled cellulosic substrate with a second surface of a cellulosic substrate (e.g., another recycled cellulosic substrate).

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a graph illustrating sealing strength as a function of liquid polyol plasticizer content for thermally sealed cellulosic substrates using a starch-based sealing solution without any pre-conditioning.

FIG. 2 is a graph illustrating sealing strength as a function of liquid polyol plasticizer content for thermally sealed cellulosic substrates using a starch-based sealing solution with pre-conditioning at 50% RH.

FIG. 3 is a graph illustrating sealing strength as a function of liquid polyol plasticizer content for thermally sealed cellulosic substrates using a starch-based sealing solution with pre-conditioning at 85% RH.

FIG. 4 is a graph illustrating sealing strength as a function of liquid polyol plasticizer content for thermally sealed cellulosic substrates using a PVOH-based sealing solution without any pre-conditioning.

FIG. 5 is a graph illustrating sealing strength as a function of liquid polyol plasticizer content for thermally sealed cellulosic substrates using a PVOH-based sealing solution with pre-conditioning at 50% RH.

FIG. 6 is a graph illustrating sealing strength as a function of liquid polyol plasticizer content for thermally sealed cellulosic substrates using a PVOH-based sealing solution with pre-conditioning at 85% RH.

### DETAILED DESCRIPTION

The disclosure relates to a method for sealing a cellulosic article in which a sealing solution is applied to one or more cellulosic substrates to form a seal between surfaces thereof. The sealing solution generally includes water, starch, a solid polyol plasticizer, and optionally a liquid polyol plasticizer. Coated surfaces of the cellulosic substrate(s) are then contacted under sufficient conditions to form the seal therebetween, for example after drying and/or with sufficient contact time, contact pressure, contact temperature, etc. The disclosure further relates to a corresponding coated cellulosic substrate and/or a sealed cellulosic article, for example as formed by the sealing method. The disclosure further relates to a method for recycling in which the sealed cellulosic article is re-pulped, with or without recovery of sealing composition components, then formed into a recycled cellulosic substrate.

### Sealing Solution

Water is generally the primary component of the sealing solution, providing an aqueous medium for dissolution of the of the starch and polyol components as well as for dispersion of any solid (e.g., insoluble fillers or additive) components. The aqueous medium in turn provides a convenient liquid medium for spraying, dipping, or other application to a cellulosic substrate to be coated, and subsequent drying to remove the water and provide a corresponding coated substrate does not involve any non-water solvent emissions (e.g., (organic solvents, etc.). In embodiments, the water is present in the sealing solution in an amount of at least 60 wt. % or 80 wt. %, such as in a range of 80 wt. % to 98 wt. %, based on the sealing solution. The sealing solution as initially applied to a cellulosic substrate surface can have any suitable amount of water to solubilize the starch and polyol plasticizer components as well as to promote the absorption of the same into the cellulosic substrate before drying to form a corresponding coated substrate and subsequent sealing. In some embodiments, the water can be present in amounts of at least 60, 70, 80, 85, 90, or 95 wt. % and/or up to 85, 90, 92, 95, 97, 98, or 99 wt. %.

The starch component of the sealing solution and corresponding coating on the cellulosic substrate is not particularly limited, for example including one or more unmodified starches and/or modified starches. Starch in its natural or unmodified form is generally a mixture of amylose and amylopectin, for example about 15-30 wt. % amylose and about 70-85 wt. % amylopectin depending on the source of the starch. In various embodiments, separation and/or techniques such as hydrolysis can be used to select a desired distribution of amylose and amylopectin components and/or to control the molecular weight of the starch components. Various modified starches (e.g., modified amylose and/or amylopectin in admixture or separately) are known in the art and can be used. A modified starch is suitably a partially modified starch in which 1% to 90% (e.g., weight, number, or mole basis) of the hydroxyl (OH) groups of the natural starch material have been functionalized, modified, or otherwise replaced with one or more groups such as an alkyl group, acetyl group, alkanoyl group, amine group, ether group, etc. For example, at least 1, 2, 5, 10, 20, 30, 40, or 50% and/or up to 10, 20, 30, 40, 50, 60, 70, 80, or 90% of the native hydroxyl groups have been modified. Likewise, the modified starch can include 10% to 99% (e.g., weight, number, or mole basis) of the original hydroxyl groups relative to the corresponding natural starch, for example at least 20, 30, or 40% and/or up to 60, 70, or 80% of the original hydroxyl groups. Examples of modified starches include partially alkylated starch, partially acetylated/alkanoylated starch, partially aminated starch (and its derivatives), partially etherified starch, etc. The foregoing alkyl, acetyl, alkanoyl, amine, and ether groups can generally be saturated or unsaturated (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., nitrogen atom for the amine group).

The solid polyol plasticizer typically contains 4 to 16 carbon atoms and is solid over a range of temperatures from 15 to 35° C. More generally, the solid polyol plasticizer is generally a polyol that is solid at common ambient or intended use temperatures, for example a polyol that is solid over a range of temperatures from 15 to 35° C. or 20 to 30° C. The solid polyol plasticizer can have a melting point of at least 40° C., for example at least 40, 60, 80, 90, 100 or 120° C. and/or up to 100, 120, 140, 160, 180, 200, or 250° C. Such solid polyols can contain 4 to 16 carbon atoms (e.g., 4 to 6, 8, 10, 12, 16 carbon atoms, such as 4, 5, 6, 7, or 8 carbon atoms), for example as a sugar alcohol. Alternatively or additionally the solid polyols can contain 4 to 12 hydroxy or alcohol (—OH) groups (e.g., 4 to 6, 8, 10, or 12 hydroxy groups, such as 4, 5, or 6 hydroxy). In some embodiments, the solid polyol plasticizer can be a partially modified solid polyol such that at least one of the hydroxy groups of the base solid polyol has been functionalized, modified, or otherwise replaced with one or more groups such as an alkyl group, ester group, amine group, carboxylic acid group, etc. The foregoing alkyl, ester, amino, and carboxylic acid groups can generally include saturated or unsaturated components (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., oxygen atoms for the ester or carboxylic acid groups). Such modified solid polyols can retain at least 1, 2, 3, or 4 and/or up to 4, 6, 8, 10, or 12 hydroxy groups.

Examples of suitable solid polyol plasticizers include one or more of isosorbide, erythritol, threitol, arabitol, xylitol, ribitol, mannitol, sorbitol, galactitol, fucitol, iditol, inositol, volemitol, isomalt, maltitol, and lactitol. The foregoing solid polyols can likewise be unmodified or modified as described above with one or more hydroxy or alcohol (—OH) groups being functionalized, modified, or otherwise replaced with one or more groups such as an alkyl group, ester group, carboxylic acid group, etc. Such modified solid polyols can retain at least 1, 2, 3, or 4 and/or up to 4, 6, 8, 10, or 12 hydroxy groups.

In some embodiments, the sealing solution and corresponding resulting coating can further include a liquid polyol plasticizer in addition to the solid polyol plasticizer. Inclusion of the liquid polyol plasticizer in the sealing solution as initially applied to a substrate surface can improve the mobility of the starch and solid polyol components upon heating and initial seal formation. This promotes contact, entanglement, and hydrogen bonding between the starch and solid polyol components with the cellulosic components of the substrate (i.e., all of which contain hydroxy groups), which in turn increases the strength of the eventual seal.

The liquid polyol plasticizer typically contains 2 to 4 carbon atoms and is liquid over a range of temperatures from 15 to 35° C. More generally, the liquid polyol plasticizer is generally a polyol that is liquid at common ambient or intended use temperatures, for example a polyol that is liquid over a range of temperatures from 15 to 35° C. or 20 to 30° C. The liquid polyol plasticizer can have a melting point of up to 30° C., for example at least −150, −100, −50, 0, 5, 10, or 15° C. and/or up to 0, 5, 10, 15, 20, 25, or 30° C. Such liquid polyols can contain 2 to 4 carbon atoms (e.g., 2, 3, or 4 carbon atoms). Alternatively or additionally the liquid polyols can contain 2 to 4 hydroxy or alcohol (—OH) groups (e.g., 2, 3, or 4 hydroxy groups). In some embodiments, the liquid polyol plasticizer can be partially modified starch such that at least one of the hydroxy groups of the base liquid polyol has been functionalized, modified, or otherwise replaced with one or more groups such as an alkyl group, ester group, carboxylic acid group, etc. The foregoing alkyl, ester, and carboxylic acid groups can generally include saturated or unsaturated components (e.g., alkenyl or alkynyl as an unsaturated alkyl group), for example with at least 1, 2, 3, 4, 6, or 8 and/or up to 2, 4, 6, 10, 12, 16, or 20 carbon atoms in addition to the other atom(s) forming the modifying group (e.g., oxygen atoms for the ester or carboxylic acid groups). Such modified liquid polyols can retain at 1, 2, or 3 hydroxy groups.

Examples of suitable liquid polyol plasticizers include of glycerin (glycerol), partially alkylated glycerin, partially alkanoated glycerin, diglycerin, triglycerin (e.g., oligo- or poly-glycerin or glycerol), 1,2-ethanediol (ethylene glycol), 1,2-propanediol (propylene glycol), 1,3-propanediol, 1,2-butanediol, 1,3-butanediol, 1,4-butanediol, and 2,3-butanediol. The foregoing liquid polyols can likewise be unmodified or modified as described above with one or more hydroxy or alcohol (—OH) group being functionalized, modified, or otherwise replaced with one or more groups such as an alkyl group, ester group, carboxylic acid group, etc. Such modified liquid polyols can retain 1, 2, or 3 hydroxy groups.

In some embodiments, the sealing solution and corresponding resulting coating can further include a filler, nanofiller, or additive in addition to the starch and polyol plasticizer components. In embodiments, the sealing solution or applied (dried) coating can include any suitable organic or inorganic filler, nanofiller, or additive, which can be included to improve one or more of mechanical properties (e.g., seal strength), sealing properties (e.g., reduced dwell or sealing time during thermal sealing), optical properties, electrical properties, and hydrophobic properties of the final seal. Example additives include wood flour, nanoclay, graphene oxide, graphene, silicon dioxide (silica), aluminum oxide, cellulose nanocrystals, carbon nanotubes, titanium dioxide (titania), talc, calcium carbonate, diatomaceous earth, biocides, pigments, dyes, and/or thermoplastics. The additives can be included in the sealing solution as applied to the cellulosic substrate. The fillers and additives can have any suitable size, for example being micro-scale or nano-scale particulates. Examples of suitable size ranges for the fillers and additives include 10 nm to 1 mm, 20 nm to 100 m, and 100 nm to 50 m, for example at least 10 nm, 20 nm, 50 nm, 100 nm, 200 nm, 500 nm, 1 μm, 2 μm, 5 μm, 10 μm, 20 μm, or 50 μm and/or up to 100 nm, 200 nm, 500 nm, 1 μm, 2 μm, 5 μm, 10 μm, 20 μm, 50 μm, 100 μm, 200 μm, 500 μm, or 1000 μm. The foregoing sizes can represent average sizes (e.g., number-, volume-, or weight-average) or upper/lower sizes for a distribution (e.g., 1/99%, 5/99%, or 10/90% sizes in a cumulative size distribution).

The amounts of starch, polyol(s), and optional fillers/additives in the sealing solution can be expressed on a wet-weight (or total) basis, including the amount of water in the sealing solution (e.g., initially present prior to application/drying). Alternatively or additionally, the amounts of starch, polyol(s), and optional additives in the sealing solution can be expressed on a dry-weight (or solids) basis, excluding the amount of water in the sealing solution. The dry-weight (or solids) basis can represent the relative amounts of components remaining after substrate coating and drying for water removal, even though relatively non-volatile liquid sealing solution components (e.g., the liquid polyol plasticizer) are still present. Accordingly, the various dry-weight (or solids) basis amounts for the sealing solution can similarly apply to the composition of the resulting coating as applied to the cellulosic substrate. Alternatively or additionally, amounts of starch, polyol(s), and optional additives can be expressed in ratios relative to one another, which ratios can apply to both the initial sealing solution and the resulting coating.

In embodiments, the starch is present in the sealing solution in an amount in a range of 1 wt. % to 15 wt. %, 1 wt. % to 20 wt. %, 1 wt. % to 30 wt. %, or 2 wt. % to 20 wt. % based on the sealing solution. More generally, the sealing solution as initially applied to a surface of the cellulosic substrate can have any suitable amount of starch in view of the desired strength of the eventual seal. In some embodiments, the starch can be present in amounts of at least 1, 2, 3, 4, 5, 6, 8, or 10 wt. % and/or up to 5, 7, 9, 12, 15, 18, 20, 25, or 30 wt. % based on the sealing solution. In embodiments with more than one type of starch, such as blends of different modified and/or unmodified starches, the foregoing ranges can apply to the total amount of starches in the sealing solution.

Alternatively or additionally, the starch can be present in the sealing solution in an amount in a range of 40 wt. % to 95 wt. % or 40 wt. % to 98 wt. % based on the combined amount of starch and all polyol plasticizers in the sealing solution (e.g., a dry-weight basis excluding water amount). For example, the starch can be present in amounts of at least 40, 50, 60, 70, or 80 wt. % and/or up to 60, 70, 80, 90, 95, or 98 wt. % based on the combined amount of starch and all polyol plasticizers. In embodiments in which the sealing solution further includes one or more optional fillers/additives, the foregoing ranges can apply similarly, but based on the combined amount of starch, all polyol plasticizers in the sealing solution, and any optional fillers/additives (i.e., excluding water). The foregoing component ranges can likewise apply to the sealing composition or coating composition as applied to a cellulosic substrate and/or in an already-sealed cellulosic article.

In embodiments, the solid polyol plasticizer is present in the sealing solution in an amount in a range of 0.5 wt. % to 7.5 wt. %, 0.5 wt. % to 10 wt. %, 0.5 wt. % to 15 wt. %, or 1 wt. % to 10 wt. % based on the sealing solution. More generally, the sealing solution as initially applied to a surface of the cellulosic substrate can have any suitable amount of solid polyol plasticizer(s) in view of the desired strength of the eventual seal. In some embodiments, the solid polyol plasticizer can be present in amounts of at least 0.5, 1, 1.5, 2, 3, 4, or 5 wt. % and/or up to 2.5, 3, 4, 5, 7.5, 10, or 15 wt. %. In embodiments with more than one type of solid polyol plasticizer, the foregoing ranges can apply to the total amount of solid polyol plasticizers in the sealing solution.

Alternatively or additionally, the solid polyol plasticizer can be present in the sealing solution in an amount in a range of 2 wt. % to 60 wt. % or 5 wt. % to 60 wt. % based on the combined amount of starch and all polyol plasticizers in the sealing solution (e.g., a dry-weight basis excluding water amount). For example, the solid polyol plasticizer(s) can be present in amounts of at least 2, 5, 10, 15, 20, 25, or 30 wt. % and/or up to 25, 30, 40, 50, or 60 wt. % based on the combined amount of starch and all polyol plasticizers. In embodiments in which the sealing solution further includes one or more optional fillers/additives, the foregoing ranges can apply similarly, but based on the combined amount of starch, all polyol plasticizers in the sealing solution, and any optional fillers/additives (i.e., excluding water). The foregoing component ranges can likewise apply to the sealing composition or coating composition as applied to a cellulosic substrate and/or in an already-sealed cellulosic article.

In embodiments, the liquid polyol plasticizer can be present in the sealing solution in an amount in a range of 0.5 wt. % to 30 wt. % based on the sealing solution. In some embodiments, the liquid polyol plasticizer can be present in amounts of at least 0.5, 1, 1.5, 2, 2.5, 3, or 4 wt. % and/or up to 2.5, 3, 4, 5, 7.5, 10, 15, 20, or 30 wt. %. In embodiments with more than one type of liquid polyol plasticizer, the foregoing ranges can apply to the total amount of liquid polyol plasticizers in the sealing solution.

Alternatively or additionally, the liquid polyol plasticizer can be present in the sealing solution in an amount in a range of 0.5 wt. % to 30 wt. % based on the combined amount of starch and all polyol plasticizers in the sealing solution (e.g., a dry-weight basis excluding water amount). For example, the liquid polyol plasticizer(s) can be present in amounts of at least 0.5, 1, 2, 5, 7, 10, 15, or 20 wt. % and/or up to 10, 15, 20, 25, or 30 wt. % based on the combined amount of starch and all polyol plasticizers. In embodiments in which the sealing solution further includes one or more optional fillers/additives, the foregoing ranges can apply similarly, but based on the combined amount of starch, all polyol plasticizers in the sealing solution, and any optional fillers/additives (i.e., excluding water). The foregoing component ranges can likewise apply to the sealing composition or coating composition as applied to a cellulosic substrate and/or in an already-sealed cellulosic article.

Alternatively or additionally, the composition of the sealing solution can be represented by the relative amount of starch to solid polyol plasticizer(s), which reflects the relative amount of the components in the original sealing solution as well as in the coating composition or on the cellulosic substrate after coating or sealing. In embodiments, a weight ratio of starch to solid polyol plasticizer(s) in the sealing solution or on the cellulosic substrate after application/sealing can be in a range of 0.1 to 40, for example being at least 0.1, 0.2, 0.5, 1, 1.5, 2, 2.5, 3, 5, or 10 and/or up to 1.5, 2, 3, 4, 6, 8, 10, 12, 15, 20, 30, 40 (i.e., where values above 1 represent a higher relative amount of starch). The foregoing component ratios can likewise apply to the sealing composition or coating in an already-coated substrate or an already-sealed cellulosic article.

Alternatively or additionally, the composition of the sealing solution can be represented by the relative amount of solid polyol plasticizer(s) to liquid polyol plasticizer(s), which reflects the relative amount of the components in the original sealing solution as well as in the coating composition or on the cellulosic substrate after coating or sealing. In embodiments, a weight ratio of solid polyol plasticizer(s) to liquid polyol plasticizer(s) in the sealing solution or on the cellulosic substrate after application/sealing can be in a range of 0.1 to 20, for example being at least 0.1, 0.2, 0.5, 1, 1.5, 2, 2.5, or 3 and/or up to 1.5, 2, 3, 4, 6, 8, 10, 12, 15 or 20 (i.e., where values above 1 represent a higher relative amount of solid polyol plasticizer(s)). The foregoing component ratios can likewise apply to the sealing composition or coating in an already-coated substrate or an already-sealed cellulosic article.

In embodiments, the sealing solution can include one or more fillers, nanofillers, or additives in an amount of 0.01 wt. % to 10 wt. %, 1 wt. % to 5 wt. %, or 0.01 wt. % to 20 wt. % based on the sealing solution, for example in amounts of at least 0.01. 0.05, 0.1, 0.2, 0.5, 1, 2, 3, 4, or 5 wt. % and/or up to 1, 2, 4, 6, 8, 10, 12, 15, or 20 wt. % based on the sealing solution. The foregoing amounts can reflect the amount of a single filler/additive, or the combined amount of all fillers/additives in the sealing solution.

Alternatively or additionally, the optional filler(s)/additive(s) can be present in the sealing solution in an amount in a range of 0.2 wt. % to 40 wt. % based on the combined amount of starch, all polyol plasticizers, and all filler(s)/additive(s) in the sealing solution (e.g., a dry-weight basis excluding water amount). For example, the filler(s)/additive(s) can be present in amounts of at least 0.2, 0.5, 1, 2, 5, 7, 10, 15, or 20 wt. % and/or up to 4, 6, 8, 10, 15, 20, 25, 30, 35, or 40 wt. % based on the combined amount of starch, all polyol plasticizers, and all filler(s)/additive(s). The foregoing component ranges can likewise apply to the sealing composition or coating composition as applied to a cellulosic substrate and/or in an already-sealed cellulosic article.

In embodiments, the sealing solution, sealing composition, or coating composition can be free or substantially free of poly(vinyl alcohol) (PVOH) and/or of other (water-soluble) polymers other than starch. For example, the sealing solution can include not more than 0.1, 0.2, 0.5, 1, or 2 wt. % PVOH and/or polymers other than starch. Alternatively or additionally, the sealing solution can include at least 95, 98, 99, 99.5, 99.8, or 99.9 wt. % of the combined amount of water, starch, all polyol plasticizers, and all filler(s)/additive(s) in the sealing solution, relative to the sealing solution as a whole (i.e., wet-weight basis). Similarly, the sealing composition or coating composition can include not more than 0.1, 0.2, 0.5, 1, or 2 wt. % PVOH and/or polymers other than starch. Alternatively or additionally, the sealing composition or coating composition can include at least 95, 98, 99, 99.5, 99.8, or 99.9 wt. % of the combined amount of starch, all polyol plasticizers, and all filler(s)/additive(s) in the sealing solution, relative to the sealing composition or coating composition as a whole (i.e., dry-weight basis excluding water removed after drying).

### Cellulosic Substrate

The cellulosic substrate is typically a porous substrate including at least one of cellulose and hemicellulose, and it can further include lignin (e.g., as a lignocellulosic substrate). In embodiments, the cellulosic substrate be selected from paper (bleached, unbleached, coated and uncoated), corrugated board, cardboard, wood, and fabric (or textile). More generally, the cellulosic substrate is not particularly limited, and can be formed from any cellulosic material desired for sealing or joining to form a corresponding article, in particular given the good, broad adhesive capabilities of the sealing solution. For example, the substrate can be a paper, wood, or fabric (or textile). Examples of paper substrates can include generally thinner, flexible papers, for example useful as wrapping materials, as well as generally thicker, rigid papers or cardboard (e.g., corrugated paper cardboard), for example useful as box, container, plate, cup, or other storage or food-service items. Suitable wood materials can be any type of wood commonly used in home, office, and outdoor settings. Suitable fabric or textile materials can include any cellulosic materials commonly used in garments or otherwise, such as cotton, jute, flax, hemp, etc.

The cellulosic substrate, corresponding coated substrate, and/or final sealed article made from the coated substrate can have any suitable shape. For example, the original substrate, coated substrate, or final sealed article can be in the form of a food-service article such as a drinking cup, a food plate, a food wrapper, etc. In other embodiments, the original substrate, coated substrate, or final sealed article can be in the form of a packaging box such as a corrugated box or cardboard box, for example for shipping and/or storage of item(s) contained in the packaging box.

In some embodiments, the cellulosic substrate prior to application of the starch/polyol sealing solution according to the disclosure is uncoated or otherwise untreated. In other embodiments, the cellulosic substrate prior to application of the starch/polyol sealing solution according to the disclosure is pre-coated or otherwise pre-treated, for example to provide a final multilayer coated substrate in the general form of (original) cellulosic substrate-precoating-starch/polyol coating, with the starch/polyol coating being on the outer or environment-facing side of the coated substrate to facilitate subsequent thermal sealing and formation of the sealed article. The pre-coating can be selected to provide some resistance or other protective benefit to the underlying cellulosic substrate, while the outer starch/polyol coating still facilitates rapid and simple formation of a thermal seal. An example of a suitable pre-coating material is poly(vinyl alcohol) (PVOH), which can help impart oil resistance to the coated substrate. In some embodiments, the pre-coating materials can include one or more organic and/or inorganic (nano)fillers to increase oxygen and water barrier properties, such as cellulose nanocrystals, graphene oxide, etc. Examples of other pre-coating materials include modified starch and/or modified PVOH (e.g., blends thereof), where the modifying groups could be water-repellent to improve the water performance such as esterified or etherfied starch or PVOH. Alternatively or additionally, the pre-coating and/or starch/solid plasticizer coating can include other biodegradable polymers, in particular polyesters such as polylactic acid (PLA), polyhydroxyalkanoates (PHAs), etc., to add water resistance. When added to the starch/polyol sealing solution for incorporation into the main sealing composition/coating, such polyesters can be included in the sealing solution or corresponding coating at level of 5-50 wt. % relative to the starch component, for example at least 5, 10, 15, 20, 25, or 30 wt. % and/or up to 20, 25, 30, 40, or 50 wt. % relative to the starch.

The coated cellulosic substrate and corresponding sealed cellulosic article can have any suitable coating load, depending on the desired properties and/or seal strength of the final coated article, number of coatings applied to the cellulosic substrate, etc. For example, the cellulosic substrate can be coated with multiple applications of the sealing solution (e.g., followed by drying in between applications) to provide a correspondingly thicker coating of desired thickness and/or coating load. It can be desirable to have a low coating load in order to keep the cost of the final coated paper low, but the coating desirably should still provide a sufficiently strong thermal seal. In some embodiments, the coated cellulosic substrate (e.g., before or after sealing) can have a coating load in a range of 1 to 100, 2 to 50, or 5 to 20 g/m² based on the coating weight (e.g., combined amount of starch, all polyol plasticizers, and all filler(s)/additive(s) in the sealing solution) per unit surface area of the coated substrate. For example, the coating load can be at least 1, 2, 3, 4, 5, 6, 8, 10, or 12 g/m² and/or up to 5, 7, 10, 12, 15, 20, 30, 40, 50, 70, or 100 g/m².

### Methods

The sealing solution in any of its various embodiments can be used to seal and form a cellulosic article from a corresponding coated cellulosic substrate, for example to form a packaging article, a food-service article, etc. The sealing method generally includes applying a sealing solution to a first surface of a cellulosic substrate, and contacting a second surface of a cellulosic substrate with the sealing solution on the first surface to form a seal between the first surface and the second surface. The sealing solution is applied to one or both of the first and second surfaces, which are then contacted under sufficient conditions to form the seal therebetween, for example with sufficient contact time, contact pressure, and/or contact temperature, etc.

In embodiments, the second surface of the cellulosic substrate also includes a second sealing solution thereon to be contacted with the first surface when forming the seal. In other embodiments, the second surface is uncoated with a sealing solution. In other embodiments, the second surface can also have a sealing solution applied thereto prior to contacting the first and second surfaces to form the seal. The second sealing solution could be the same or different from that applied to the first surface, but the second sealing solution generally has the same options for components, amounts, etc. as the sealing solution applied to the first surface.

In embodiments, cellulosic substrate can be dried to remove at least some of the water from the sealing solution after applying the sealing solution to the first surface and/or second surface of the cellulosic substrate. Suitably, the first and/or second surfaces are allowed to dry or are dried prior to contacting to form the seal, which provides time for the starch and any polyol plasticizers to be absorbed into and transported throughout the cellulosic substrate via capillary transport prior to evaporation or removal of water, which in turn provides a stronger eventual seal. Drying can be performed at ambient conditions or with some applied heat. Drying can performed until there is no longer any visible surface water or liquid on the surface of the cellulosic substrate, for example where at least 80, 85, 90, or 95 wt. % and/or up to 90, 95, 98, 99, or 100 wt. % of the water from the initial sealing solution has been removed prior to sealing.

In embodiments, contacting the second surface with the first surface to form the seal therebetween can include applying pressure and/or heat to the first surface and the second surface to form the seal. In various embodiments, application of pressure during sealing can be performed a pressure in a range of 0.5 bar to 30 bar (e.g., about 7 psi to about 440 psi), for example at least 0.5, 1, 2, 5, 7, or 10 bar and/or up to 5, 10, 15, 20, 25, or 30 bar. In various embodiments, application of heat during sealing can be performed a temperature in a range of 100° C. to 400° C., for example being above the melting point of the solid polyol, at least 100, 120, 150, or 200° C., and/or up to 150, 200, 250, 300, or 400° C. In various embodiments, the first and second surfaces can be contacted during application of pressure and/or heat for a contact time or dwell time in a range of 0.2 s to 10 s, for example at least 0.2, 0.5, or 1 s and/or up to 2, 3, 4, 5, 7, or 10 s.

In various embodiments, the first surface and the second surface can be from the same or different cellulosic substrate(s). For example, the sealed surfaces can be different regions of the same cellulosic substrate, such as where the substrate is bent, folded, or otherwise shaped/deformed to contact and join the first and second surfaces. Alternatively, the sealed surfaces can be on different cellulosic substrates, for example where two separate substrates are joined into a unitary article after contacting and joining the first and second surfaces to form the seal.

The disclosure further relates to a method for recycling a cellulosic article that has been formed/sealed with the disclosed sealing solution or otherwise includes the disclosed sealing/coating composition thereon. The method includes pulping a coated cellulosic substrate or corresponding cellulosic article in a pulping medium, and the forming a recycled cellulosic substrate from the pulped cellulosic article. The pulping process is not particularly limited and can include conventional pulping techniques known in the art of paper manufacturing, recycling, and/or other processing. The disclosed sealing method above can then be applied to the recycled cellulosic substrate, thereby coating and sealing the recycled cellulosic substrate to form a sealed recycled cellulosic article.

In some embodiments, the starch, the solid polyol plasticizer, and the liquid polyol plasticizer (when present) are not removed from the pulping medium prior to forming recycled cellulosic substrate. The starch, the solid polyol plasticizer, and the liquid polyol plasticizer initially present in the seal of the original cellulosic article being recycled would generally be solubilized in the pulping medium. These sealing composition components can remain in the pulping medium and be reincorporated into the recycled cellulosic substrate, for example as a sizing agent. The sealing composition components would generally be homogenously distributed throughout the recycled cellulosic substrate, for example at the relative ratios described above for the sealing composition/sealing solution.

In other embodiments, the recycling method further removing and recovering the starch, the solid polyol plasticizer, and the liquid polyol plasticizer (when present) from the pulping medium prior to forming recycled cellulosic substrate. The recovered sealing composition components can be recycled to form a new sealing solution for the sealing of other cellulosic substrates. In contrast to the previous embodiment, the recycled cellulosic substrate would generally not contain the sealing composition components homogeneously distributed throughout.

### EXAMPLES

The following examples illustrate the disclosed compositions and methods, but are not intended to limit the scope of any claims thereto.

### Example 1: Sealing Solutions and Sealed Articles

This example illustrates representative sealing solutions according to the disclosure as well as their use to seal cellulosic articles. Sealed articles formed with the sealing solutions were evaluated for their sealing and physical properties under a variety of different environmental conditions.

Materials: Corn starch powder, glycerol, xylitol, sorbitol, isosorbide, and poly(vinyl alcohol) (PVOH) (80% hydrolyzed with Mw=9000-10,000 g/mol) were obtain from Sigma-Aldrich and used as received. Deionized (DI) water was used as the aqueous medium for the sealing solutions. 35-liner Kraft paper (ULINE) was used as the cellulosic substrate for the various sealed test articles. A commercial recyclable barrier paper (ECOSHIELD; available from Cortec Corporation, St. Paul, MN) was also used as a comparative reference.

Starch solution: A comparative 6 wt % starch solution was prepared by heating 94 mL of DI water to 95° C. Once the water became hot, 6 g of starch powder was added slowly to the beaker under constant stirring. The beaker was covered, and the solution was stirred more for about 20 minutes to provide a starch solution used for sealing comparative/control samples.

Sealing solution: A sealing solution according to the disclosure, including starch, a solid polyol plasticizer, and a liquid polyol plasticizer, was prepared by initially heating 90 mL of DI water to 95° C. in a beaker. Once the water was warm, 1 g of glycerol (liquid polyol plasticizer), 6 g of starch and 3 g of one of the solid polyol plasticizers (xylitol, sorbitol, or isosorbide) were added to the water under constant stirring. The solution was heated for another 20 minutes to provide a uniform solution used for sealing cellulosic substrates in samples according to the disclosure.

Coating method: A bar coater K303 Multi Coater (RK PRINTCOAT Instruments Ltd, UK) with rod number 8 was used to coat cellulosic (paper) substrates. About 5 mL of the coating solution was applied on test cellulosic substrate of about 29 cm×21 cm size Kraft paper. The coated paper was dried at room temperature (about 20-25° C.) for 24 h.

Thermal sealing: The coated papers were thermally sealed with a CERATEK thermal sealing instrument (SencorpWhite; Hyannis, MA). The seal heat was set to 300° F. (149° C.) with a cycle time of 10 s and pressure of 45 psi (0.31 MPa). The coated papers were cut into a thin strip of about 50.8 mm×25.4 mm size. The two strips were held by facing the coated sides (i.e., the sides with dried sealing solution residue thereon) together. The two facing strips were put between the top and bottom board of thermal sealer and sealed for 10 s. The sealed strips were then cooled to room temperature and pre-conditioned at 50% or 85% relative humidity (RH) at 25° C. for ˜40 h.

Sealing strength: The sealing strength of the sealed strips was determined using an INSTRON instrument following TAPPI standard with a 5565 Universal Instron testing machine (Instron, MA, USA). A thermally sealed strip specimen of about 50.8 mm×25.4 mm size made from the facing coated papers was attached to the two clamps of the instrument with a gap of 25.4 mm between the clamps. The specimen was stretched at a constant rate of 254 mm/min. The data was recorded using a BLUEHILL software package (Instron, MA, USA). The sealing strength was recorded as the maximum load the seal could withstand (e.g., before delaminating or other destruction/detachment).

Basis weight and coating load: The basis weight of the coated paper was calculated with ASTM D646 protocol. Coated and uncoated (control) papers were cut into 12 cm×12 cm square pieces. The basis weight of the uncoated and coated paper was calculated by dividing the weight of the paper in grams with the area in m² (i.e., expressed in units of g/m²). The coating load was calculated by subtracting the basis weight of the uncoated paper from the basis weight of the coated paper (i.e., providing a coating load value also expressed in units of g/m²).

Repulpability: The repulpability of the coated and commercial papers was studied with a repulpability procedure. For this procedure, 5 g of a paper specimen was soaked into 300 mL of water which was heated to 50° C. The paper was soaked for 30 minutes. After this, the paper was grinded in a mixer for 20 minutes. The pulp obtained was filtered using a mesh and rinsed with 100 mL of water. The pulp was pressed and dried at 100° C. The amount of fiber recovered was calculated by dividing the amount of pulp obtained after repulping with the original paper weight (i.e., 5 g).

Results: Different aqueous sealing formulations including starch, glycerol as a liquid polyol plasticizer, and/or various solid polyol plasticizers were tested for their ability to form coatings on and then thermally seal paper substrates. The sealing solutions included 6.9 wt. % starch, 0.1-3 wt. % glycerol (when present), and 3 wt. % solid polyol plasticizer (when present), balance water. For each concentration of glycerol included (i.e., 0, 0.1, 0.5, 1.0, or 3.0 wt %), three sets of coatings were prepared: one with glycerol but no solid polyol plasticizer, one with no glycerol or solid polyol plasticizer, and one with both glycerol and plasticizer (xylitol/sorbitol/isosorbide). Table 1 shows the different formulations that were tested.

TABLE 1
Aqueous Sealing Formulations

| | Starch | Glycerol | Solid Polyol | | Water |
|---|---|---|---|---|---|
| Sample | (wt. %) | (wt. %) | (wt. %) | | (wt. %) |
| Starch/control | 6.9 | — | — | | 93.1 |
| SG | 6.9 | 0.1-3.0 | — | | 90.1-93.0 |
| SGSor | 6.9 | 0.1-3.0 | 3.0 | (Sorbitol) | 87.1-90.0 |
| SGXyl | 6.9 | 0.1-3.0 | 3.0 | (Xylitol) | 87.1-90.0 |
| SGIso | 6.9 | 0.1-3.0 | 3.0 | (Isosorbide) | 87.1-90.0 |

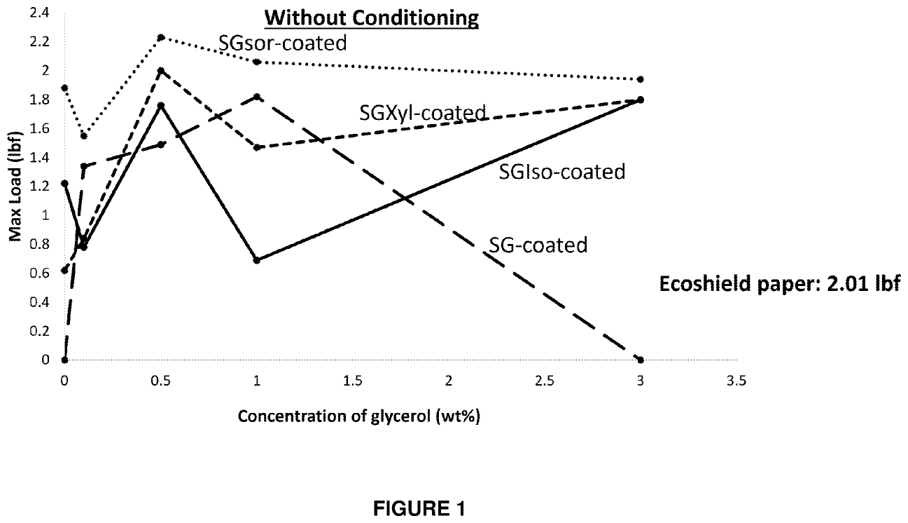

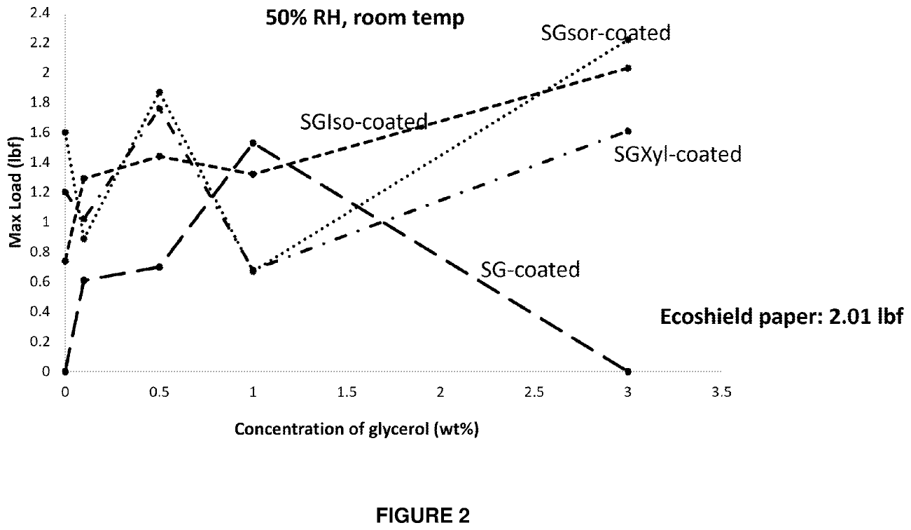

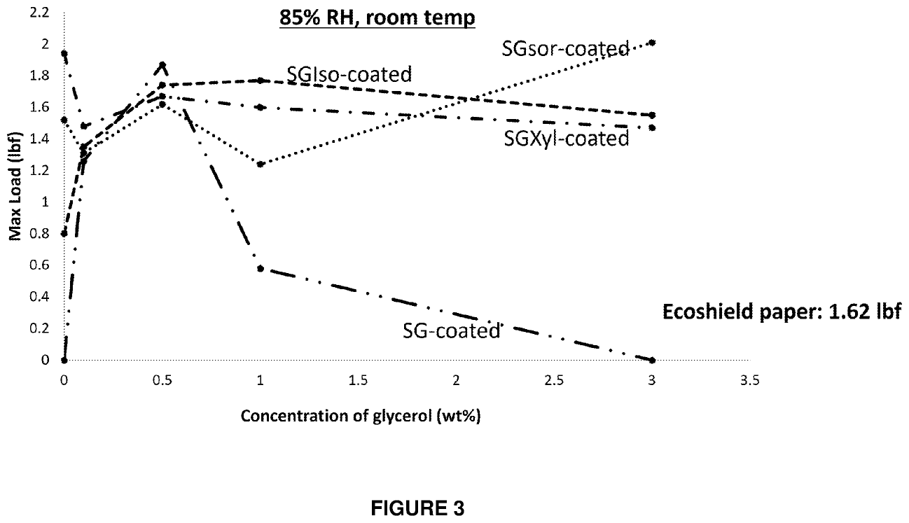

The papers were coated with the formulated solutions, dried/cured to form a dried coating on the paper substrates, and then thermally sealed as described above. The coated papers were either (i) pre-conditioned at 50% or 85% RH at room temperature (about 20-25° C.) for 40 h, or (ii) unconditioned. The sealing strength of the thermally sealed papers was evaluated and compared with a commercial reference (ECOSHIELD paper). The sealing strength results (expressed as maximum load) as a function of glycerol amount in the sealing solution are summarized in FIGS. 1-3. It was observed that the performance of the coated papers improved as the relative humidity was increased from no conditioning to 50% to 85% RH.

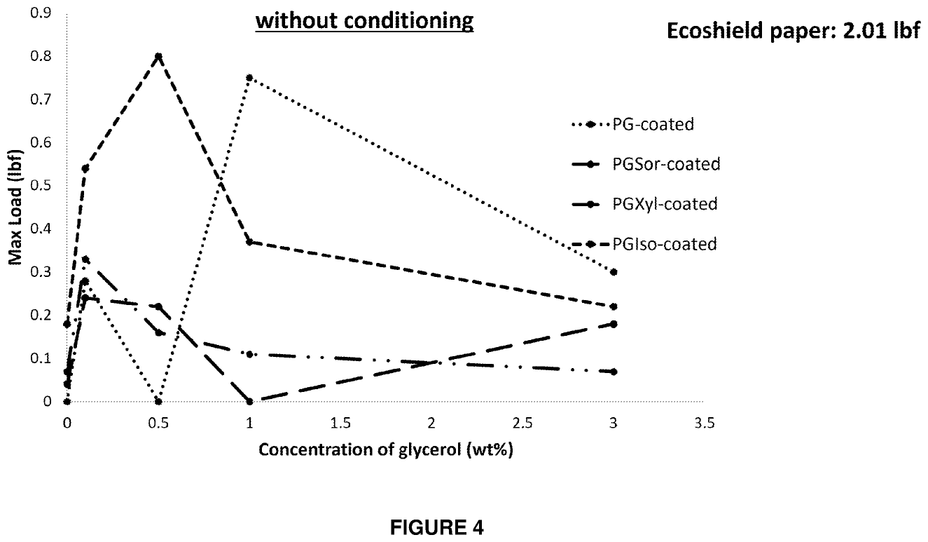

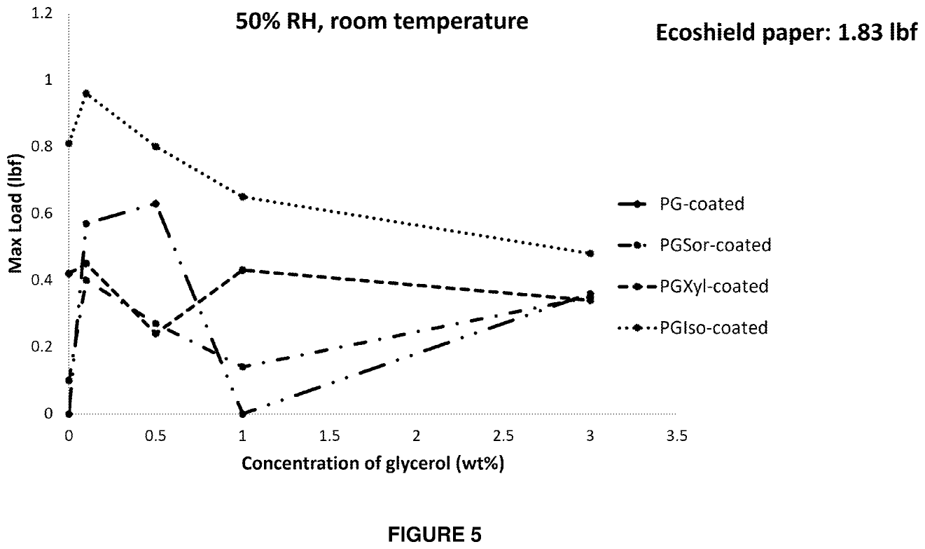

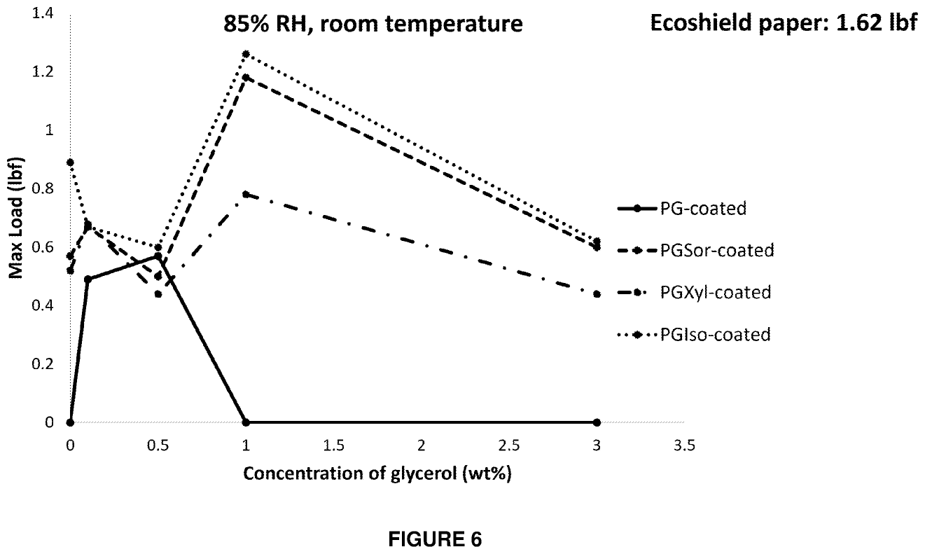

Effect of poly(vinyl alcohol) (PVOH): Additional samples were evaluated in which the starch component of the various sealing solutions was replaced by PVOH. The same formulations as in Table 1 above were prepared and tested, except that the 6.9 wt. % starch component was replaced with 6.9 wt. % PVOH. The sealing strength results (expressed as maximum load) as a function of glycerol amount in the sealing solution are summarized in FIGS. 4-6, where “PG” is a PVOH-glycerol solution, “PGSor” is a PVOH-glycerol-sorbitol solution, “PGXyl” is a PVOH-glycerol-xylitol solution, and “PGlso” is a PVOH-glycerol-isosorbide solution. It was observed that the performance of the PVOH-coated papers in general showed poor performance as compared to the starch coated and commercially available papers.

Coating load: For commercially useful coated papers, it is desirable to have a low coating load in order to keep the cost of the final coated paper low, but the coating desirably should still provide a sufficiently strong thermal seal. Hence, the coating load was evaluated for the coated paper that provided better performance. It was found that for a formulation with 0.5 wt. % glycerol, 6.5 wt. % starch and 3 wt. % sorbitol, the coating load was 16 g/m². Additional formulations were tested to evaluate the coating load as shown in Table 2. The coating was done with rod number 8 unless specified otherwise, and the coated papers were conditioned at room temperature under 85% RH for 40 h. It was observed that the sealing strength of the papers were compromised with reduced coating load.

TABLE 2

| | | | max | coating | % coating |
|---|---|---|---|---|---|
| Composition | | | load(Ibf) | load(g/m2) | load |
| 62% starch: | 6% | | 1.16 | 11.3 | 8.13 |
| 32% sorbitol: | glycerol | | | | |
| 6% glycerol | | | | | |
| 50% starch: | 25% | | 1.33 | 10.22 | 7.4 |
| 25% sorbitol: | glycerol | | | | |
| 25% glycerol | | | | | |
| 62% starch: | 6% | 10% less | 0.63 | 10.4 | 8.11 |
| 32% sorbitol: | glycerol | sorbitol | | | |
| 6% glycerol | | 50% less | 0.54 | 10.4 | 7.93 |
| | | sorbitol | | | |
| 50% starch: | 25% | 10% less | 0.89 | 10.4 | 7.74 |
| 25% sorbitol: | glycerol | sorbitol | | | |
| 25% glycerol | | 50% less | 1.32 | 13.1 | 9.3 |
| | | sorbitol | | | |
| 6.5% starch: | 0.5 | rod 3 | 0.43 | 6.8 | 5.04 |
| 3% sorbitol: | glycerol | rod 6 | 1.56 | 10.4 | 7.6 |
| 0.5% glycerol | | rod 8 | 1.87 | 16 | |

Repulpability: The coated papers were compared with the commercial paper for repulpability. As the papers used in this example contain only starch, glycerol, sorbitol, xylitol, and/or isosorbide in their coating formations, there was no plastic waste generated. All the coating materials were easily soluble in water and hence were easy to be washed out. It was also calculated that the amount of fibers recovered for 62:32:6 and 50:25:25 wt % starch:sorbitol:glycerol formulations was 84%, indicating that the majority of the pulp fibers were recovered and can be used for further use.

### Examples 2-3: Sealing Solutions and Sealed Articles with Nanofillers

These examples illustrate representative sealing solutions further including nanofillers according to the disclosure as well as their use to seal cellulosic articles. Sealed articles formed with the sealing solutions were evaluated for their sealing and physical properties.

Example 2: Sealing solutions including 6 wt. % starch, 3 wt. % sorbitol as a solid polyol plasticizer, 3 wt. % glycerol (98% purity) as a liquid polyol plasticizer, 0.1-20 wt. % titanium dioxide solid nanofiller (about 0.34 micron size) relative to total starch/polyol components, and balance water were prepared to evaluate the effect of including nanofillers at a range of different concentrations. The sealing solutions were heated and stirred until the starch and polyol components were fully dissolved and the solid nanofiller particles were fully dispersed in the aqueous medium. The sealing solutions were used to coat and seal cellulosic substrates as generally described in Example 1 above. Briefly, the sealing solutions were then coated on Kraft paper test substrates and dried at room temperature (about 20-25° C.) for 24 hours. Coated substrates were sealed using a thermal sealing machine at 301° F. (149° C.) and 20 psi (0.14 MPa), for variable dwell times ranging from 1-3 seconds. Finally, the tensile force of the sample adhesion was tested as described in Example 1 for sealing strength. The inclusion of the titanium dioxide nanofiller improved the sealing strength and reduced the dwell time to about 1-2 seconds while still providing a seal with sufficient strength. In contrast, analogous sealing compositions without the solid nanofiller required a dwell time of about 10 seconds to obtain a comparable seal strength.

Example 3: Sealing solutions including 6 wt. % starch, 3 wt. % sorbitol as a solid polyol plasticizer, 3 wt. % glycerol (98% purity) as a liquid polyol plasticizer, 0.1-20 wt. % calcium carbonate solid nanofiller relative to total starch/polyol components, and balance water were prepared to evaluate the effect of including nanofillers at a range of different concentrations. The sealing solutions were used to coat and seal cellulosic substrates as described in Example 2. Similar to the results for Example 2, the inclusion of the calcium carbonate nanofiller improved the sealing strength and reduced the dwell time to about 1-2 seconds while still providing a seal with sufficient strength, while analogous sealing compositions without the solid nanofiller required a dwell time of about 10 seconds to obtain a comparable seal strength. The improvement in dwell time was most pronounced at nanofiller levels of about 2-5 wt. % relative to total starch/polyol components for both titanium dioxide and calcium carbonate.

### Examples 4-5: Sealing Solutions and Sealed Articles with Aging

These examples illustrate representative sealing solutions further including nanofillers according to the disclosure as well as their use to seal cellulosic articles. Sealed articles formed with the sealing solutions were evaluated for their sealing and physical properties under varying aging conditions.

Example 4: Sealing solutions including 6 wt. % starch, 3 wt. % sorbitol as a solid polyol plasticizer, 3 wt. % glycerol (98% purity) as a liquid polyol plasticizer, 2 wt. % titanium dioxide solid nanofiller, and balance water were prepared to evaluate the effect of aging on a sealed article. The sealing solutions were heated and stirred until the starch and polyol components were fully dissolved and the solid nanofiller particles were fully dispersed in the aqueous medium. The sealing solutions were used to coat and seal cellulosic substrates as generally described in Example 1 above. Briefly, the sealing solutions were then coated on Kraft paper test substrates and dried at room temperature (about 20-25° C.) for 24 hours. Coated substrates were sealed using a thermal sealing machine at 301° F. (149° C.) and 20 psi (0.14 MPa), for variable dwell times ranging from 1-3 seconds. Finally, the thermally sealed articles were aged for either 1 day or 5 days under open/ambient environmental conditions (e.g., about 20-25° C., but no controlled relative humidity), and then the tensile force of the sample adhesion was tested as described in Example 1 for sealing strength (MPa) and break elongation (%). After 1 day of aging after sealing, the samples had an average modulus (automatic) of 6.58 MPa and break elongation of 46.96%; after 5 days of aging after sealing, the samples had an average modulus (automatic) of 7.43 MPa and break elongation of 49.25%. The results demonstrated that sealed articles using the disclosed sealing solution retain their good seal strength and other mechanical properties over time without substantial degradation (e.g., corresponding to times for shipping, storage, etc. of a packaged item in the sealed article).

Example 5: The same sealing solutions and coating methods as used in Example 4 were used in Example 5. Example 5 differed in that coated paper substrates were aged for either 1 day or 5 days under open/ambient environmental conditions (e.g., about 20-25° C., but no controlled relative humidity) prior to thermally sealing the paper substrates and testing the sealed articles for their sealing and mechanical properties, and the sealed articles were not further aged after sealing. After 1 day of aging after coating/prior to sealing, the samples had an average modulus (automatic) of 9.11 MPa and break elongation of 50.30%; after 5 days of aging after coating/prior to sealing, the samples had an average modulus (automatic) of 11.05 MPa and break elongation of 34.50%. The results demonstrated that coated substrates using the disclosed sealing solution retain their ability to form articles with good seal strength and other mechanical properties over time without substantial degradation (e.g., corresponding to times for storage, etc. of a coated substrate prior to it being used to package item in a sealed article formed from the coated substrate). Accordingly, Examples 4-5 together demonstrated the ability of the sealing solution and corresponding coated substrate/sealed articles to perform well in practical applications where time delays due to storage, shipping, and other supply chain considerations are common.

### Example 6: Biodegradability of Sealed Articles

Two cellulosic substrates (Samples 6.1 and 6.2) coated using sealing solutions and according to the disclosure were tested for biodegradability along with a uncoated cellulosic substrate (control). Briefly, ASTM D6868 was used to measure percent/fraction of carbon evolution from the test substrates as a function of elapsed time. In particular, aerobic biodegradation was evaluated in compost under simulated controlled composting conditions (58±2° C. and 50±5% RH) by analysis of evolved carbon dioxide using an in-house built direct measurement respirometer (DMR), equipped with a non-dispersive infrared gas analyzer (NDIR). The carbon content of the different materials was determined by elemental analysis, and the results were correlated to percent carbon evolution (or mineralization) as a function of time, with higher carbon evolution/mineralization values representing a higher biodegradability. Articles with suitable biodegradability preferably achieve at least 90% carbon evolution within 60 days. Table 3 below summarizes the biodegradability results, which show that both the coated substrates and the uncoated cellulosic substrate control achieved the 90% carbon evolution threshold on comparable timescales and well under the 60-day target. In Table 3, the high initial values above 100% for times of 15 days or less in Samples 6.1 and 6.2 are a result of a priming effect due to the rapidly degradable starch and polyol components present in the samples, but not the cellulosic control; the longer-time results in Table 3 (after about 25 days) do not include the priming effect and the results between the samples and control are comparable to reflect the relative degree of biodegradability of the cellulosic substrate.

TABLE 3
Biodegradability Results—% Carbon Evolution

| Elapsed Time | Sample 6.1 | Sample 6.2 | Cellulosic Control |
|---|---|---|---|
| 5 days | 74% | 84% | 18% |
| 10 days | 141% | 116% | 45% |
| 15 days | 111% | 92% | 74% |
| 20 days | 101% | 88% | 87% |
| 25 days | 97% | 88% | 95% |
| 30 days | 97% | 91% | 96% |
| 35 days | 103% | 96% | 100% |
| 40 days | 100% | 94% | 104% |
| 50 days | 98% | 93% | 102% |
| 60 days | 96% | 92% | 102% |

### Example 7: Multilayer Sealed Articles

This example illustrates sealed articles using sealing solutions according to the disclosure to seal cellulosic substrates already including an underlying coating (i.e., a multilayer coating on a cellulosic substrate).

Sealing solutions including 6 wt. % starch, 3 wt. % sorbitol as a solid polyol plasticizer, 3 wt. % glycerol (98% purity) as a liquid polyol plasticizer, and balance water were prepared by heating and stirring until the starch and polyol components were fully dissolved. A poly(vinyl alcohol) (PVOH) coating was first applied to a cellulosic Kraft paper test substrate by coating a drying the substrate with an aqueous PVOH solution. The PVOH-coated substrate was then further coated, dried, and sealed using the starch-sorbitol-glycerol sealing solution as generally described in Example 1 above. The resulting coated substrate had a multilayer structure of cellulosic substrate-PVOH-starch/sorbitol/glycerol. The multilayer coated substrate showed both excellent oil resistance and thermal sealing properties.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for sealing a cellulosic article, the method comprising:
applying a sealing solution to a first surface of a cellulosic substrate, the sealing solution comprising:
(i) water in an amount of at least 60 wt. % based on the sealing solution,
(ii) starch in an amount in a range of 1 wt. % to 20 wt. % based on the sealing solution, and
(iii) a solid polyol plasticizer in an amount in a range of 0.5 wt. % to 10 wt. % based on the sealing solution; and
contacting a second surface of a cellulosic substrate with the sealing solution on the first surface to form a seal between the first surface and the second surface.

2. The method of claim 1, wherein the water is present in the sealing solution in an amount in a range of 80 wt. % to 98 wt. % based on the sealing solution.

3. The method of claim 1, wherein the starch is selected from the group consisting of unmodified starch, modified starch, and combinations thereof.

4. The method of claim 1, wherein the starch is present in the sealing solution in an amount in a range of 1 wt. % to 15 wt. % based on the sealing solution.

5. The method of claim 1, wherein the solid polyol plasticizer contains 4 to 16 carbon atoms and is solid over a range of temperatures from 15 to 35° C.

6. The method of claim 1, wherein the solid polyol plasticizer is selected from the group consisting of isosorbide, erythritol, threitol, arabitol, xylitol, ribitol, mannitol, sorbitol, galactitol, fucitol, iditol, inositol, volemitol, isomalt, maltitol, lactitol, and combinations thereof.

7. The method of claim 1, wherein the solid polyol plasticizer is present in the sealing solution in an amount in a range of 0.5 wt. % to 7.5 wt. % based on the sealing solution.

8. The method of claim 1, wherein:
the starch is present in the sealing solution in an amount in a range of 40 wt. % to 95 wt. % based on the combined amount of starch and all polyol plasticizers in the sealing solution; and
the solid polyol plasticizer is present in the sealing solution in an amount in a range of 5 wt. % to 60 wt. % based on the combined amount of starch and all polyol plasticizers in the sealing solution.

9. The method of claim 1, wherein:
a weight ratio of starch to solid polyol plasticizer in the sealing solution is in a range of 0.1 to 40.

10. The method of claim 1, wherein the sealing solution further comprises (iv) a liquid polyol plasticizer in an amount in a range of 0.5 wt. % to 30 wt. % based on the sealing solution.

11. The method of claim 10, wherein the liquid polyol plasticizer contains 2 to 4 carbon atoms and is liquid over a range of temperatures from 15 to 35° C.

12. The method of claim 10, wherein the liquid polyol plasticizer is selected from the group consisting of glycerin, partially alkylated glycerin, partially alkanoated glycerin, diglycerin, triglycerin, 1,2-ethanediol, 1,2-propanediol, 1,3-propanediol, 1,2-butanediol, 1,3-butanediol, 1,4-butanediol, 2,3-butanediol, and combinations thereof.

13. The method of claim 10, wherein:
the solid polyol plasticizer comprises sorbitol; and
the liquid polyol plasticizer comprises glycerin.

14. The method of claim 10, wherein:
the starch is present in the sealing solution in an amount in a range of 40 wt. % to 98 wt. % based on the combined amount of starch and all polyol plasticizers in the sealing solution;
the solid polyol plasticizer is present in the sealing solution in an amount in a range of 2 wt. % to 60 wt. % based on the combined amount of starch and all polyol plasticizers in the sealing solution; and
the liquid polyol plasticizer is present in the sealing solution in an amount in a range of 0.5 wt. % to 30 wt. % based on the combined amount of starch and all polyol plasticizers in the sealing solution.

15. The method of claim 10, wherein:
a weight ratio of starch to solid polyol plasticizer in the sealing solution is in a range of 0.1 to 40; and
a weight ratio of solid polyol plasticizer to liquid polyol plasticizer in the sealing solution is in a range of 0.1 to 20.

16. The method of claim 1, wherein the cellulosic substrate is selected from the group of paper, corrugated board, cardboard, wood, and fabric.

17. The method of claim 1, wherein the cellulosic substrate is in the form of a food-service article selected from the group consisting of a drinking cup, a food plate, and a food wrapper.

18. The method of claim 1, wherein the cellulosic substrate is in the form of a packaging box.

19. The method of claim 1, wherein the sealing solution further comprises a filler in an amount in a range of 0.01 wt. % to 10 wt. % based on the sealing solution.

20. The method of claim 1, further comprising:
after applying the sealing solution to the first surface of the cellulosic substrate, drying the cellulosic substrate thereby removing at least some of the water from the sealing solution.

21. The method of claim 1, wherein contacting the second surface with the first surface comprises at least one of applying pressure to the first surface and the second surface and applying heat to the first surface and the second surface to form the seal.

22. The method of claim 1, wherein the second surface comprises a second sealing solution thereon to be contacted with the first surface when forming the seal.

23. The method of claim 1, wherein the first surface and the second surface are from the same cellulosic substrate.

24. The method of claim 1, wherein the first surface and the second surface are from different cellulosic substrates.

25. A cellulosic article comprising:
a first surface of a cellulosic substrate sealed to a second surface of a cellulosic substrate formed by the method of claim 1.

26. A cellulosic article comprising:
a first surface of a cellulosic substrate sealed to a second surface of a cellulosic substrate at an interface between the first surface and the second surface; and
a sealing composition at the interface binding the first surface to the second surface, the sealing composition comprising:
(i) starch in an amount in a range of 40 wt. % to 98 wt. % based on the combined amount of starch and all polyol plasticizers in the sealing composition,
(ii) a solid polyol plasticizer in an amount in a range of 2 wt. % to 60 wt. % based on the combined amount of starch and all polyol plasticizers in the sealing composition, and
(iii) optionally a liquid polyol plasticizer in an amount in a range of 0.5 wt. % to 30 wt. % based on the combined amount of starch and all polyol plasticizers in the sealing composition.

27. The cellulosic article of claim 26, wherein:
a weight ratio of starch to solid polyol plasticizer in the sealing composition is in a range of 0.1 to 40; and
a weight ratio of solid polyol plasticizer to liquid polyol plasticizer in the sealing composition is in a range of 0.1 to 20.

28. A method for recycling a cellulosic article, the method comprising:
providing a cellulosic article according to claim 26;
pulping the cellulosic article in a pulping medium; and
forming a recycled cellulosic substrate from the pulped cellulosic article.

29. The method of claim 28, wherein:
the starch, the solid polyol plasticizer, and the liquid polyol plasticizer (when present) are not removed from the pulping medium prior to forming recycled cellulosic substrate.

30. The method of claim 28, further comprising:
removing and recovering the starch, the solid polyol plasticizer, and the liquid polyol plasticizer (when present) from the pulping medium prior to forming recycled cellulosic substrate.

31. The method of claim 28, further comprising:
performing a sealing method on the recycled cellulosic substrate, thereby forming a seal on at least a first surface of the recycled cellulosic substrate with a second surface of a cellulosic substrate, wherein the sealing method comprises:
applying a sealing solution to a first surface of the recycled cellulosic substrate, the sealing solution comprising:
(i) water in an amount of at least 60 wt. % based on the sealing solution,
(ii) starch in an amount in a range of 1 wt. % to 20 wt. % based on the sealing solution, and
(iii) a solid polyol plasticizer in an amount in a range of 0.5 wt. % to 10 wt. % based on the sealing solution; and
contacting a second surface of the recycled cellulosic substrate with the sealing solution on the first surface to form a seal between the first surface and the second surface.

32. The method of claim 1, comprising applying the sealing solution to the first surface of the cellulosic substrate at a temperature of 15° C.-35° C.

33. The method of claim 1, wherein the sealing solution comprises the water in an amount in a range of 60 wt. % to 85 wt. % based on the sealing solution.

34. The method of claim 1, wherein the sealing solution contains not more than 0.5 wt. % of modified starch based on the sealing solution.
